(19) United States
(12) Patent Application Publication
(10) Pub. No.: US 2009/0220829 A1
(43) Pub. Date: Sep. 3, 2009

(54) Solid Oxide Fuel Cell

(76) Inventors: Anna Berta Lopes Correia Tavares, Varennes (CA); Boris L. Kuzin, Ekaterinburg (RU); Nina M. Bogdanovich, Ekaterinburg (RU); Sergey M. Beresnev, Ekaterinburg (RU); Edhem Kh. Kurumchin, Ekaterinburg (RU); Antonio Zaopo, Milano (IT); Yuri A. Dubitsky, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/583,734

(22) PCT Filed: Dec. 24, 2003
(86) PCT No.: PCT/EP2003/014999

§ 371 Date: Oct. 23, 2008

(51) Int. Cl. H01M 8/04; H01M 8/10; H01M 8/12; H01M 4/86

(52) U.S. Cl. 429/17; 429/30; 429/33; 502/101

(57) ABSTRACT

Solid oxide fuel cell including an anode which has a cermet activated by a catalyst for hydrocarbon oxidation, process for the preparation thereof, and method for the production of energy exploiting it.

### BACKGROUND OF THE INVENTION

The present invention relates a solid oxide fuel cell, to a method for producing energy by means thereof, and to a process for preparing said solid oxide fuel cell.

### PRIOR ART

As reported, for example, by S. Park et al., Applied Catalysis A: General 200 (2000), 55-61, fuel cells, e.g. solid oxide fuel cells (SOFCs), have received a great deal of attention as environmentally friendly and efficient means to generate energy, e.g. electrical power, for both stationary and mobile applications. The adoption of fuel cell, however, has been limited by a variety of technological hurdles including the fact that most conventional fuel cell designs require H₂ to be used as the fuel. This limitation is particularly significant for transportation applications where infrastructure and safety considerations favor the use of hydrocarbon fuel.

Reforming of hydrocarbons to produce H₂ is one approach that has been put forth to circumvent this problem. Unfortunately, reforming involves a complex set of catalytic reactions that must be carried out at temperatures higher than 850° C. to be effective. Such thermal requirements involve the use of special material for the construction of the fuel cell, with a consequent increasing of the cost.

Solid oxide fuel cells that could oxidize hydrocarbon fuels directly, without internally or externally reforming them to H₂, would have significant advantages over traditional systems that require reforming, as reported, e.g., by Lu et al., J. Electrochem. Soc, 150 (10), A1357-A1359 (2003). An essential requirement for the direct oxidation of hydrocarbons in the absence of steam is that the materials used in anode fabrication do not catalyze carbon formation. Therefore, nickel (Ni), the most commonly used metal for SOFC anode, must be replaced with a different electronic conductor, since Ni catalyzes the formation of carbon filaments when exposed to hydrocarbons at SOFC operating temperatures. Replacement of Ni with copper (Cu), a poor catalyst for carbon formation was reported, for example, by S. Park et al., J. Electrochem. Soc., 146, 3603 (1999). Ceria (CeO₂) is included in the anode to enhance anode performance, in part because of catalytic activity of ceria for the oxidation of hydrocarbon fuels.

C. Lu et al., J. Electrochem. Soc, 150(3), A354-A358 (2003) disclose Cu-SDC (samaria-doped ceria) and Cu—CeO₂—SDC anodes for SOFC, obtained by impregnating a porous layer of SDC (porosity of approximately 50%) with aqueous solutions of Cu(NO₃)₂ and Ce(NO₃)₃ to give a final weight percent with respect to the weight of the porous SDC matrix of 16% for Cu and 10% for CeO₂. Said anodes are tested in a cell fed with butane (C₄H₁₀) at 600-700° C. The maximum power density with C₄H₁₀ fuel is 170 mW/cm² at 700° C. for the cell with the Cu—CeO₂-SDC anode.

C. Lu et al., J. Electrochem. Soc, 150(10), A1357-A1359 (2003) show the comparison of Cu—CeO₂—SDC and Au—CeO₂—SDC composites for SOFC anodes, prepared in a manner similar to that of the just discussed paper, and describe as “relatively poor” the power density obtained in cells with said anodes performing in dry C₄H₁₀ at 650° C.

It has to be considered that methane (CH₄) is much less reactive than butane in heterogeneous oxidation and exhibits the lowest reactivity for the anodes as well, as reported by R. J. Gorte, Electrochem. Soc. Proc., 2202-5, 60-71.

The need of a SOFC performing by directly oxidizing hydrocarbon fuels, and especially methane, and providing significant current and power densities with long lasting performances is still felt. Also, a sought characteristic for a SOFC is the possibility of operating at temperatures lower than 800° C.

### SUMMARY OF THE INVENTION

The Applicant perceived that one of the key-points for affording such desired performance is the homogeneous distribution in the anode of the three functionalities for performing the cell, i.e. catalytic activity and ionical and electronical conductivity (three-phase boundary).

Applicant found that the problem could be solved by a SOFC with an anode comprising a cermet wherein the metallic and the electrolyte ceramic material portions are substantially uniformly interdispersed, the metallic portion being devoid of catalytic activity for hydrocarbon oxidation. Moreover, said cermet has a high porosity which allows the homogeneous distribution of a catalyst for hydrocarbon oxidation throughout the entire volume of the cermet. In view of such a homogeneous distribution, small amounts of catalyst are required for activating the cermet and making the anode to operate when fed with a hydrocarbon fuel.

Therefore, the present invention relates to a solid oxide fuel cell including a cathode, an anode and at least one electrolyte membrane disposed between said anode and said cathode, wherein said anode comprises
a cermet including a metallic portion and an electrolyte ceramic material portion, said portions being substantially uniformly interdispersed, said metallic portion having a melting point equal to or lower than 1200° C. and being substantially inert as catalyst for hydrocarbon oxidation; said cermet having a porosity equal to or higher than 40%, and being activated by a catalyst for hydrocarbon oxidation in an amount equal to or lower than 20 wt %.

In the present description and claims as “substantially uniformly interdispersed” is meant that the portions of the cermet are intimately admixed in the entire volume of the cermet, and not merely overlaid one another.

The metallic portion of the cermet can be selected from a metal such as copper, aluminum, gold, praseodymium, ytterbium, cerium, and alloys thereof. Preferably, said metallic portion is copper.

Preferably the metallic portion has a melting point higher than 500° C. Preferably the electrolyte ceramic material portion has a specific conductivity equal to or higher than 0.01 S/cm at 650° C. For example, it is doped ceria or La₁₋ₓSrₓGa_{1-y}Mg_{y}O_{3-δ} wherein x and y are comprised between 0 and 0.7 and δ is from stoichiometry. Preferably, the ceria is doped with gadolinia (gadolinium oxide) or samaria (samarium oxide).

Alternatively, the ceramic material of the SOFC of the invention is yttria-stabilized zirconia (YSZ).

In the cermet of the invention the weight ratio metallic portion/ceramic portion preferably ranges between 9:1 and 3:7, preferably between 8:2 and 5:5.

The cermet of the present invention advantageously has a specific surface area equal to or lower than about 5 m²/g, more preferably equal to or lower than about 2 m²/g.

The catalyst activating the cermet suitable for the invention can be selected from nickel, iron, cobalt, molybdenum, platinum, iridium, rhutenium, rhodium, silver, palladium, cerium oxide, manganese oxide, molybdenum oxide, titania, samaria-doped ceria, gadolinia-doped ceria, niobia-doped ceria and mixtures comprising them. Preferably it is selected from nickel, cerium oxide and mixtures comprising them.

The amount of said catalyst can advantageously range between about 0.5 wt % and about 15 wt %. The percentages disclosed for the amount of the catalyst are expressed with respect to the total weight of the anode.

Advantageously the catalyst suitable for the invention has a specific surface area higher than 20 m²/g, more preferably higher than 30 m²/g.

According to an embodiment of the invention, a first type of cathode for the solid oxide fuel cell of the invention comprises a metal such as platinum, silver or gold or mixtures thereof, and an oxide of a rare earth element, such as praseodymium oxide.

According to another embodiment of the invention, a second type of cathode comprises a ceramic selected from
La₁₋ₓSrₓMnO_{3-δ}, wherein x and y are independently equal to a value comprised between 0 and 1, extremes included and δ is from stoichiometry; and

La₁₋ₓSrₓCo_{1-y}Fe_{y}O_{3-δ}, wherein x and y are independently equal to a value comprised between 0 and 1, extremes included and δ is from stoichiometry.

Said second type of cathode can further comprise doped ceria.

According to a further embodiment of the invention, a third type of cathode comprises a combination of the materials above mentioned for the cathodes of the first and second type.

Preferably, the electrolyte membrane of the SOFC of the invention is selected from the materials listed above in connection with the electrolyte ceramic material portion of the cermet. More preferably, the electrolyte membrane comprises the same material of the electrolyte ceramic portion of the cermet suitable for the invention.

In another aspect, the present invention relates to a method for producing energy comprising the steps of:

a) feeding at least one hydrocarbon fuel into an anode side of a solid oxide fuel cell comprising
an anode including a cermet including a metallic portion and an electrolyte ceramic material portion, said portions being substantially uniformly interdispersed, said metallic portion having a melting point equal to or lower than 1200° C. and being substantially inert as catalyst for hydrocarbon oxidation; said cermet having a porosity equal to or higher than 40%, and being activated by a catalyst for hydrocarbon oxidation in an amount equal to or lower than 20 wt %;
a cathode, and
at least one electrolyte membrane disposed between said anode and said cathode;
   b) feeding an oxidant into a cathode side of said solid oxide fuel cell; and
   c) oxidizing said at least one fuel in said solid oxide fuel cell, resulting in production of energy.

The hydrocarbon fuel suitable for the method of the invention can be in gaseous form, e.g. methane, ethane, propane, butane, natural gas, reformed gas, biogas, syngas and mixture thereof, either in the presence of water or substantially dry; or a hydrocarbon in liquid form, e.g. diesel, toluene, kerosene, jet fuels (JP-4, JP-5, JP-8, etc).

Advantageously, the hydrocarbon fuel is substantially dry. As “substantially dry” it is intended that the water content can be lower than 10 vol %. Preferred for the present invention is substantially dry methane.

In the method according to the invention the hydrocarbon fuel can be directly oxidized at the anode side. For instance, in the case of methane, the reaction at the anode is the following

CH₄+4O²⁻→CO₂+2H₂O+8e⁻

As already said above, the direct oxidation of a dry fuel such as a dry hydrocarbon yields coking phenomena (deposition of graphite fibers) at the catalyst of the anode thus exhausting its catalytic activity. The phenomenon is particularly reported when nickel is used as catalyst. The structure of the anode of the invention allows the activating catalyst to effectively perform without being affected by such deposition phenomenon. Thus the solid oxide fuel cell of the present invention can perform by direct oxidation of a dry fuel.

Advantageously, the solid oxide fuel cell of the invention operates at a temperature ranging between about 400° C. and about 800° C., more preferably between about 500° C. and about 700° C.

Besides the possibility of skipping the necessity of using special thermo-resistant material for manufacturing the solid oxide fuel cell, an advantage provided by low operating temperatures, such those preferred by the present invention, is the reduction of NOₓ formation at the cathode. The formation of such undesired by-products is due to the reaction of the nitrogen present in the air fed at the cathode side, such reaction being related to temperature increase.

The solid oxide fuel cell according to the invention substantially displays a great flexibility in the choose of the fuel to be fed with. Besides hydrocarbons, it can performs by feeding the anode also with hydrogen, or with an wet hydrocarbon fuel (in the case of methane, generally 1:3 methane/water) to provide reformed fuel.

In case of operating with reformed fuel, the fuel can be internally reformed at the anode side.

The solid oxide fuel cell can be prepared with methods known in the art. Advantageously it is prepared by the following process.

In a further aspect, the present invention relates to a process for preparing a solid oxide fuel cell including a cathode, an anode and at least one electrolyte membrane disposed between said anode and said cathode wherein said anode comprises a cermet including a metallic portion and an electrolyte ceramic material portion; said process comprising the steps of:
providing the cathode;
providing the at least one electrolyte membrane; and
providing the anode
   wherein the step of providing the anode includes the steps of:
a) providing a precursor of the metallic portion, said precursor having a particle size ranging between 0.2 μm and 5 μm;
b) providing the electrolyte ceramic material having a particle size ranging between 1 μm and 10 μm;
c) mixing said precursor and said ceramic material to provide a starting mixture;
d) heating and grinding said starting mixture in the presence of at least one first dispersant;
e) adding at least one binder and at least one second dispersant to the starting mixture from step d) to give a slurry;
f) thermally treating the slurry to provide a pre-cermet;
g) reducing the pre-cermet to provide a cermet
h) distributing at least one catalyst for hydrocarbon oxidation into the cermet.

Unless otherwise indicated, in the present description and claims as “particle size” is intended the average particle size determined by physical separation methods, for example by sedimentography, as shown hereinbelow.

According to an embodiment of the invention, the slurry resulting from step e) is applied on the electrolyte membrane.

According to an embodiment of the invention, step h) comprises impregnating the pre-cermet with a precursor of the catalyst which is subsequently reduced during the reducing step g).

According to another embodiment of the invention, step h) comprises impregnating the cermet with a precursor of the catalyst which is subsequently reduced during an additional reducing step i).

Preferably the precursor of the metallic portion is an oxide of the metals already listed above. For example, in the case of copper the oxide is Cu₂O or CuO, the latter being preferred.

Preferably said precursor has a particle size ranging between 1 and 3 μm.

Preferably the ceramic material has a particle size ranging between 2 and 5 μm.

Advantageously, step d) is effected more than one time.

The first dispersant is a solvent or a solvent mixture. Preferably it is selected from polar organic solvents, such as alcohols, polyols, esters, ketones, ethers, amides, optionally halogenated aromatic solvents such as benzene, chlorobenzene, dichlorobenzene, xylene and toluene, halogenated solvents such as chloroform and dichloroethane, or mixtures thereof. It ensures homogeneity to the starting mixture. Examples are provided in Table 1.

The second dispersant can be the same or different from the first dispersant.

Advantageously, the binder is soluble in the second dispersant. Preferably it is selected from polymeric compounds containing polar groups such as polyvinylbutyral, nitrocellulose, polybutyl methacrylate, colophony, ethyl cellulose. Examples of mixtures binder/second dispersant are provided in Table 1.

TABLE 1

| Binder | Dispersant |
|---|---|
| Polyvinylbutyral | ethanol |
| | ethanol + benzene |
| | ethanol + acetone + butyl alcohol |
| | ethanol + isopropanol + monomethyl ether |
| | ethylene glycol |
| | isopropanol |
| | isopropanol + ethyl acetate + sebacic acid |
| | dibutyl ether |
| Nitrocellulose | isoamylacetate + tetrahydrofurane |
| Polybutyl methacrylate | ethyl acetate |
| | butyl acetate |
| | acetone + butanol |
| | isopropanol + isoamylacetate + ethyl acetate |
| Colophony | ethanol + dichlorobenzene |
| Ethyl cellulose | ethyleneglycol monoethyl ether + p-xylene |

Preferred binder is polyvinylbutyral. Preferred first and second dispersants are ethanol and isopropanol.

Advantageously, step f) is carried out at a temperature ranging between about 700° C. and about 1100° C., more preferably between about 900° C. and about 1000° C.

The reduction step g) is preferably carried out at a temperature ranging between about 300° C. and about 800° C., more preferably between about 400° C. and about 600° C.

Hydrogen is a preferred reducing agent. Advantageously, it is introduced in the reduction environment, for example an oven, which has been previously conditioned with an inert gas, such as argon. Advantageously, hydrogen contains from 1 vol. % to 10 vol. % of water, preferably from 2 vol. % to 5 vol. %.

Advantageously, the precursor of the catalyst is a salt thereof.

In another further aspect the present invention relates to a cermet including a metallic portion and an electrolyte ceramic material portion, said portions being substantially uniformly interdispersed, said metallic portion having a melting point equal to or lower than, 1200° C. and being substantially inert as catalyst for hydrocarbon oxidation; said cermet having a porosity equal to or higher than 40%, and being activated by a catalyst for hydrocarbon oxidation in an amount equal to or lower than 20 wt %.

### BRIEF DESCRIPTION OF THE DRAWINGS

The invention will be further illustrated hereinafter with reference to the following examples and figures, wherein

FIG. 1 schematically illustrates a fuel cell power system;

FIG. 2 shows the variation of the electric resistance upon temperature of a Cu-SDC cermet suitable for the invention;

FIGS. 3a and 3b are micrographs of a Cu-SDC cermet in (a) secondary electron emission and (b) backscattering modes;

FIG. 4 shows the experimental set-up for testing the solid oxide fuel cells of the invention;

FIG. 5 shows anodic polarization curves of a Cu-SDC anode activated with CeO₂+Ni fed with CH₄ at 547, 595 and 646° C.;

FIG. 6 shows cell potential and power density as function of the current density in a fuel cell fed with CH₄ at 596, 645 and 696° C.;

FIG. 7 shows anodic polarization curves of a Cu-SDC anode activated with CeO₂+Ni+MoOₓ fed with CH₄ at 599, 648 and 698° C.;

FIG. 8 shows the performance of a SOFC MoOₓ+Ni+CeO₂—(Cu-SDC)/SDC/Pt+PrO₂₋ₓ, fed with CH₄ at 600, 645 and 700° C.;

FIG. 9 shows anodic polarization curves of Cu-SDC cermet activated with MoOx+Ni+CeO₂ in CH₄/air fuel cell after (□) 25 h and (◯) 46 h in CH₄+3% H₂O mixtures, and further (Δ) 7 h in CH₄+3% H₂O atmosphere.

### DETAILED DESCRIPTION OF THE PREFERRED EMBODIMENTS

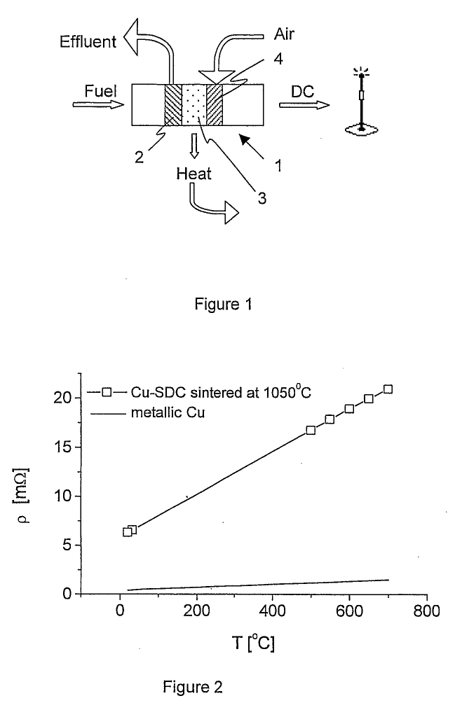

FIG. 1 schematically illustrates a solid oxide fuel cell power system. The solid oxide fuel cell (1) comprises an anode (2), a cathode (4) and an electrolyte membrane (3) disposed between them.

According to a preferred embodiment of the invention, a substantially dry fuel is fed to the anode (2) where direct oxidation is effected. The heat can be used in a bottoming cycle, while the electric power in form of direct current (DC) can be exploited as such, for example in telecommunication systems, or converted into alternate current (AC) via a power conditioner (not illustrated).

From anode (2) an effluent flows which can be composed by unreacted fuel and/or reaction product/s, for example water and/or carbon dioxide.

### Example 1

### Preparation of a Cu-SDC (54 wt %-46 wt %) cermet with Cu₂O+Ce_{0.8}Sm_{0.2}O_{1.9} as starting materials

### A. Starting Mixture

Cu₂O powder (“analytically pure” grade, >99.5%) was ground in the drum of a “sand” planetary mill with jasper balls using isopropanol as dispersant. The drum was charged with 50 g of the powder oxide, 150 g of balls, and 45 ml of isopropanol. The procedure was carried out for 30 minutes at a drum speed of 110 rpm.

After the dispersant was removed in oven at 100° C., the specific surface area (S) of the ground powder (determined by low-temperature adsorption of nitrogen in a Sorpty-1750 device, Carlo Erba, Italy) and the average particle size (d) (determined by CP-2 centrifugal sedimentographer, Shimadzu, Japan) were measured and found to be S_{Cu}_{₂}_{O}=1.7 m²/g and d_{Cu}_{₂}_{O}=1.8 μm, with a normal particle size distribution from 0 to 2.1 μm.

The ground Cu₂O and Ce_{0.8}Sm_{0.2}O_{1.9} (SDC) powder (S_{SDC}1.9 m²/g and d_{SDC}=3.3 μm) were mixed together in a planetary mill with jasper balls in the presence of isopropanol. The charge of the drum included 25 g of the powder mixture 72.4 wt % Cu₂O+27.6 wt % SDC (18.1 g Cu₂O and 6.9 g SDC), 50 g of balls and 25 ml of isopropanol. The procedure was carried out for 50 minutes at a speed of 80 rpm and for 10 minutes at 110 rpm. The dispersant was removed in oven at 100° C., and the Cu₂O-SDC mixture was added with a 5 wt % aqueous solution of polyvinyl alcohol (PVA) as binder (10 wt % of the powder mass). Pellets 20 mm in diameter were prepared by semi-dry compaction method at a specific pressure of about 30 MPa.

A heat treatment was performed at 800° C. with a 1.5 hour isothermal holding time and air blasting. The pellets were heated and cooled at a rate of 250° C./hour. After the heat treatment, the pellets changed color from brown to black. The diameter shrinkage and the geometrical density of the sintered pellets were 1.7% and 4.05 g/cm³ respectively.

The pellets were broken in a jasper mortar to obtain grains ≦1.25 mm in size. The coarse-grain powder was ground in a “sand” planetary mill with jasper balls in the presence of isopropyl alcohol. The charge of the mill drum did not exceed ⅔ of their volume. The powder/dispersant ratio was maintained at ˜1:0.95. The grinding conditions were: powder/balls ratio of 1:3, n (grinding speed)=110 rpm, grinding time=45 min. An average surface area S=2.9 m²/g and average particle size d)=2.7 μm were measured for the resulting powder. The powder was used to prepare a slurry.

### B. Slurry

The powder mixture of A. was ground in the drum of a “sand” planetary mill with jasper balls. Polyvinyl butyral (PVB) was used as binder and ethanol as dispersant. The charge included 20 g of the powder mixture, 8 ml of 5 wt % solution of PVB in ethanol, and 15 ml of ethyl alcohol. Four jasper balls, 14 mm in diameter, were put per 20 g of the powder. The charge was mixed for 30 min at a speed of 80 rpm. The resulting slurry was poured into a vessel outfitted with a tight cover to prevent evaporation of the dispersant.

### C. Pre-Cermet.

The slurry of B. was brushed onto an SDC electrolyte membrane (1.82 mm-hick) while stirring. An amount of 16±4 mg/cm² (corresponding to a thickness of 65±5 μm) was applied by three brushings with intermediate drying in a warm air jet.

The slurry/electrolyte membrane assembly was then heated in air at 1050° C. under the following conditions: heating at a rate of 200° C./hour in the interval from 20 to 500° C. and at a rate of 250° C./hour in the interval from 500° C. to the experimental temperature. The assembly was kept under isothermal conditions for 2 hours at the final temperature, then cooled at a rate 200° C./hour to provide a pre-cermet/electrolyte membrane assembly.

The final thickness of the pre-cermet in the pre-cermet/electrolyte membrane assembly was 42 μm and the thickness shrinkage was 38.7% pointing for a good sintering of pre-cermet layer.

The density of the applied slurry and the pre-cermet was calculated from mass and geometrical dimensions, and accounted for 45% and 64% of the design density, respectively. Thus, the porosity of the pre-cermet was of about 36%.

The porosity value was also evaluated by mercury porosimetry. The pre-cermet material was deposited on ten plates of SDC electrolyte to a total mass of 0.448 g. The experiments were carried out on PA-3M mercury porosimetric installation, and the volume normalized for 1 g of pre-cermet material was 0.0776 cm³. The volume porosity was then calculated from the following equation:

$$p = \frac{0.0776}{( 1 / ( \begin{matrix}m ( {CuO}_{x} ) \times d ( {CuO}_{x} ) + \\ m ( SDC ) \times d ( SDC )\end{matrix} ) + 0.0776} \qquad ( 1 )$$

where m_{CuOx} and in m_{SDC} indicate the relative weight amount of the phases in the pre-cermet, and d_{CuOx} and d_{SDC} the specific densities of Cu₂O (6 g/cm³) and SDC (7.13 g/cm³) phases.

The measured volume porosity was 34±3%, which is in agreement with the porosity estimated from mass and geometric values. The average size of the pores was seen to be 1 μm.

### D. Reduction of the Pre-Cermet to Cermet.

After cooling to room temperature, the pre-cermet of the pre-cermet/electrolyte membrane assembly of C. was reduced at a temperature of 500° C. (at a rate of 200° C./hour). The oven was conditioned with argon (3 vol. % H₂O), then hydrogen (3 vol. % H₂O) was introduced to replace argon and kept for 40 min.

### E. Morphological Characterization of the Cu-SDC Cermet.

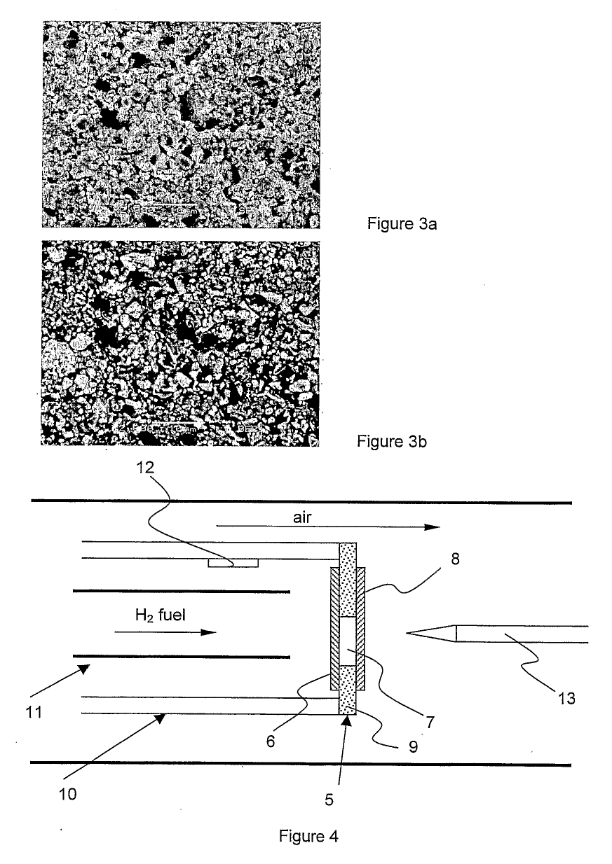

Morphological characterization of the Cu-SDC cermet was effected using a scanning electron microscope (JSM-5900LV). FIGS. 3a and 3b represent two micrographs of the outer surface of the anode, respectively in the secondary electron emission mode (FIG. 3a) and in the backscattering mode (FIG. 3b). From these two pictures it can be seen that the cermet has a porous structure where both phases (Cu and SDC) are intimately mixed and homogeneously distributed.

As metallic copper forms an amalgam with mercury, the above described method cannot be used to determine the cermet porosity. The porosity of the cermet was calculated considering the following:
a) the volume of the cermet does not change with the reduction process (V_{pre-cermet(ox)}=V_{cermet(red)})
b) the volume of the SDC electrolyte phase does not change with the reduction process (V_{SDC(ox)}=V_{SDC(red)})
c) the variation in cermet porosity upon reduction is due to the variation of volume of copper containing phases, and the following relation (2) can be applied:

$${V}_{{CuO}_{x}} - {V}_{Cu} = {V}_{{CuO}_{x}} ( 1 - ( \frac{{d}_{{CuO}_{x}}}{{d}_{Cu}} ) + ( \frac{Δ m}{{d}_{Cu}} ) ) \qquad ( 2 )$$

where Δm is the mass difference between the copper and copper oxide, and d_{CuOx} and d_{Cu} are, respectively the density of copper oxide CuO (6 g/cm³) and metallic copper (8.9 g/cm³).

Considering 1 g of oxidized cermet (the cermet pre-reduction), its volume V_{pre-cermet(ox)} is given by:

$$\begin{matrix}{V}_{pre - cermet} ( ox ) = {V}_{SDC} ( ox ) + {V}_{CuOx} ( ox ) + {V}_{pore} ( ox ) \\ or & ( 3 ) \\ {V}_{pre - cermet} ( ox ) = \frac{{m}_{SDC} ( ox )}{{d}_{SDC} ( ox )} + \frac{{m}_{CuOx} ( ox )}{{d}_{CuOx} ( ox )} + {V}_{pore} ( ox ) & ( 4 )\end{matrix}$$

where m_{SDC} and m_{CuOx} are the mass of both phases in the cermet. Being Vₚₒᵣₑ(ox)=0.36V_{pre-cermet}(ox) (from porosimetry measurements), equation (4) can be rewritten as:

$$( 1 - 0.36 ) {V}_{pre - cermet} ( ox ) = \frac{{m}_{SDC} ( ox )}{{d}_{SDC} ( ox )} + \frac{{m}_{CuOx} ( ox )}{{d}_{CuOx} ( ox )} + {V}_{pore} ( ox ) \qquad ( 5 )$$

and the calculated value for V_{pre-cermet}(ox) is 0.249 cm³.

As the porosity volume of the reduced cermet, Vₚₒᵣₑ(red) is given by:

Vₚₒᵣₑ(red)=Vₚₒᵣₑ(ox)+ΔV (6)

and equal to 0.143 cm³, the final porosity of the cermet Vₚₒᵣₑ(red)/V_{cermet}(red) was of 55%.

The specific surface area was determined by the nitrogen BET method (Sorpty 1750, Carlo Erba Strumentazione, Italy) and resulted to be 1.6 m²/g.

### F. Measurement of the Electrical Resistance of the Cu-SDC Cermet.

The layer resistance (measured along the major layer axis) of the cermet was measured by the dc four-probe method using an EC-1286 device (Solartron Schlumberger). The cermet had a surface of 1×1 cm² and was 42 μm-thick. Current and potential probes were made of platinum wire.

The following procedure was used. After reduction of the pre-cermet layer to cermet, the sample was further heated in hydrogen (3 vol. % H₂O) up to 700° C. at a rate of 200° C./hour. The temperature was maintained for 2 hours, then sequential measurements of resistance were done and the stability of the cermet anode was ascertained. The sample was cooled to 500° C. by steps of 50° C. at a rate of 100° C./hour and step time of 10 min, and its resistance was measured at each grade. Finally, the sample was cooled at a rate of 200° C./hour to room temperature and its resistance was measured again.

The results are shown in FIG. 2. The cermet has a metallic behavior with a resistance increasing with temperature. This reads for a uniform distribution of the metallic phase through the cermet.

The electric resistance longitudinally along the anode, 1×1 cm² in size and 0.004 cm thick, changes between 6.3 mΩ and 21.0 mΩ at a temperature from 20 to 700° C. The results are set forth in Table 2 below.

### Example 2

### Preparation and Characterization of a Cu-SDC (70 Wt %-30 Wt %) Cermet Using CuO and SDC Starting Materials

The same preparation procedure described in example 1 was used with CuO (15 g) and SDC (6.37 g) as starting material. The ground CuO had a total specific surface area (S) of 0.9 m²/g and a mean particle size (d) of 3.4 μm at a normal particle size distribution from 0 to 20 μm.

The same amount of slurry (16±4 mg/cm²) was deposited on a SDC electrolyte, and after the heat treatment at 1050° C. the final thickness of the pre-cermet was 39 μm; the thickness shrinkage was 33.7% indicating a good sintering of electrode structure.

The final thickness of the pre-cermet was 43.6 μm and the thickness shrinkage was 32.5% indicating a good sintering of the structure.

The porosity of the pre-cermet before reduction was 36%, and after reduction was 54.4%.

The electrical resistance along the cermet was measured according to example 1. The measured values (5.8 mΩ at 20° C. and 23.0 mΩ at 700° C.) are according to the requirements for an anodes used in fuel cells, as set forth in Table 2.

TABLE 2
Electrical resistance and specific conductivity
alone the Cu-SDC anodes

| Example | Resistance at 20° C. (mΩ) | Resistance at 700° C. (mΩ) |
|---|---|---|
| 1 | 6.3 | 21.0 |
| 2 | 5.8 | 23.0 |

### Example 3

### Activation of Cu-SDC Cermet with SDC

A Cu-SDC cermet prepared according to example 1 was activated by impregnation with SDC oxide material. The Cu-SDC cermet in the reduced state was impregnated with a solution of Ce(OCOC(CH₃)₂C₄H₉)₃ and Sm(OCOC(CH₃)₂C₄H₉)₃ (cerium and samarium 2,2-dimethyl-hexanoate) in benzene (4 g/100 ml). Filtering paper was used to remove the excess solution from the cermet surface. The cermet was impregnated dried and heat treated (400° C.) three times. The activated cermet was then heated at a rate of 200° C./h up to 650° C. in H₂ (3 vol. % water) and the total amount of deposited SDC was 0.27 mg (6 wt %). The specific surface area of the SDC phase was 56.2 m²/g.

### Example 4

### Activation of Cu-SDC Cermet with CeO₂

A Cu-SDC cermet prepared according to example 2 was activated by impregnation with CeO₂. The Cu-SDC cermet in the reduced state was impregnated with a solution of Ce(NO₃)₂ in water (140 g/100 ml). Filtering paper was used to remove the excess solution from the cermet surface. The cermet was impregnated dried and heat treated (400° C.) twice. The activated cermet which was then heated at a rate of 100° C./h up to 650° C. in H₂ (3 vol. % water), and total amount of deposited CeO₂ was 8.42 mg (15.4 wt %). The specific surface area was determined by the nitrogen BET method (Sorpty 1750, Carlo Erba Strumentazione, Italy), and resulted to be for CeO₂ of 39.4 m²/g.

### Example 5

### Activation of a Cu-SDC Cermet with Ni+CGO

A Cu-SDC cermet prepared according to example 2 was activated with a mixture of Ni (70 wt %) and CGO (Ce_{0.8}Gd_{0.2}O_{1.9}; 30 wt %). The Cu-SDC cermet in reduced state was impregnated with a solution of 4 g/100 ml of M(OCOC(CH₃)₂C₄H₉)ₓ wherein M-=e, Gd and Ni, x is from stoichiometry (3.29 g of Ni precursor, 0.67 g of Ce precursor and 0.04 g of Gd precursor) in C₆H₆. Filtering paper was used to remove the excess of solution from the cermitic surface. The cermet was impregnated, dried and heat treated (400° C.) thrice. The activated cermet was and heated at a rate of 200° C./h up to 650° C. in H₂ (3 vol. % water). The total amount of deposited activator was 0.1 mg (2 wt %). The specific surface area of the activator was of 135 m²/g.

### Example 6

### Activation of a Cu-SDC Cermet with CeO₂+Ni

A Cu-SDC cermet prepared according to example 2 was activated with CeO₂ and Ni. First the Cu-SDC cermet in reduced state was impregnated with a solution of Ce(NO₃)₃ in water (140 g/100 ml H₂O). Filtering paper was used to remove the excess of solution from the cermitic surface. The cermet was impregnated, dried and heat treated (500° C.). Then the activated cermet was impregnated with a solution of Ni(NO₃)₂ in water (167.5 g/100 ml H₂O). Filtering paper was used to remove the excess of solution from the cermitic surface. The cermet was impregnated, dried and heat treated (500° C.). The resulting activated cermet was dried and heated up to 500° C. with the rate 100° C./h in H₂ (3 vol. % water). The total amount of deposited activator was 0.45 mg CeO₂ and 0.1 mg Ni (9 wt % and 2 wt %, respectively).

The specific surface areas were determined by the nitrogen BET method (Sorpty 1750, Carlo Erba Strumentazione, Italy), first for CeO₂ and subsequently for Ni. CeO₂ showed a specific surface area of 39.4 m²/g, and Ni showed a specific surface area of 84.6 m²/g.

### Example 7

### Evaluation of a Solid Oxide Fuel Cell with Anode Comprising a Cu-SDC Cermet Activated with Ni—CeO₂

The electrochemical measurements under conditions of a CH₄/air were effected as follows.

A three-electrode cell (5) as from FIG. 4 was used. The cell comprised an anode (6), an electrolyte membrane (7) and a cathode (4). Anode (6) and electrolyte membrane (7) were a disk-shaped anode/electrolyte membrane assembly (Ø=12 mm) wherein the anode layer was as from the title and the electrolyte membrane was SDC. A fine Pt+PrOₓ paste was painted as cathode (8) on the surface of the electrolyte membrane (7) opposite to that in contact with the anode (6) (SU invention certificate No. 1.786.965). Each of anode (6) and cathode (8) had an area of about 0.3 cm². A reference electrode (9) was made of a platinum coil on the circumference of the electrolyte membrane (7). The three-electrode cell was pressed by a spring load against the rim of a zirconium dioxide tube (10).

Methane fuel gas (3 vol. % H₂O, V_{CH}_{₄}˜2-5 l/hour) was fed to the anode side through an alumina tube (11) positioned inside the zirconium dioxide tube (10). The cathode side was blown with air (v=6 l/hour). The composition of the combusted anode cermet was determined by means of a solid electrolyte oxygen sensor (12). The cell temperature was measured by a chromel-alumel thermocouple (13).

The overvoltage of the electrodes and the ohmic voltage drop in the electrolyte were determined under stationary conditions (galvanostatic mode) by the current interruption method. The length of the current interruption edge did not exceed 0.3 μs. The off-current state time of the cell was ˜0.3 ms (millisecond). The relative duration of the cut-off pulses (off/on) was ≦1/1540.

The measuring set-up included the following instruments:
universal digital voltmeter type B7-39 (0.02% accuracy class);
universal digital oscillograph type C₉₋₈ (1.5% accuracy class);
dc power source type VIP-009;
relay switch unit type RSD-725;
programmed temperature controller type TP-403;
IBM PC 286 AT personal computer,
gas flow-rate regulator type SRG-23.

The instruments and the computer communicated via a COP interface bus (IEEE-488).

The following measurement procedure of was used. Methane (3 vol. % H₂O) was flown at 2 l/hour and the cell heated to a temperature of 700° C. at a rate of 200° C./hour. The cell (5) was allowed to stand for 0.5 hour before its polarization characteristics were measured. The measurements were made between 700° C. and 500° C., decreasing temperature. To check the time stability of the characteristics, the measurements were repeated at 700° C. The stability of the cell was ascertained.

The Cu-SDC cermet activated with Ni—CeO₂ (example 6) was tested as anode for polarization measurement. FIG. 4 illustrates polarization curves recorded under methane (3% H₂O, V_{CH}_{₄}=2.7 l/h) at three different temperatures, 547° C., 595° C. and 646° C. The cermet Ni+CeO₂ provides an anode having remarkable activity in methane oxidation. For example, at 646° C. to a polarization of 50 mV corresponds to the current density of 0.38 A/cm².

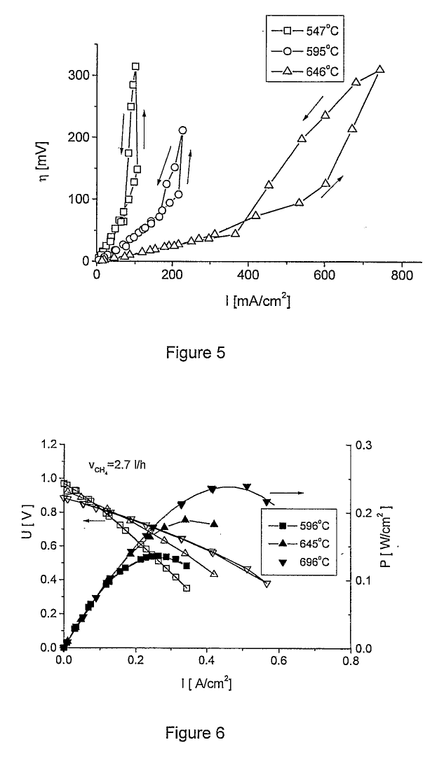

FIG. 5 shows the characteristic performance of potential and power density as function of the current density of the single fuel cell with an anode as said above, a SDC 0.0250 cm thick electrolyte membrane and a Pt+PrO₂₋ₓ, cathode, fed with CH₄/air at 596, 645 and 696° C. The measured OCV voltages (U_{oc}) are near 0.9 V. Taking into account the value predicted by the Nernst equation (about 1.0 V at 800° C.), the obtained OCV voltages indicate that methane is efficiently oxidized. At 696° C. a maximum power density of 0.24 W/cm² was measured at 0.45 A/cm².

### Example 8

### Solid Oxide Fuel Cell with a Cu-SDC Cermet Activated with [Ni+CeO₂]+MoOx

The Cu-SDC cermet activated with Ni—CeO₂ (example 6) was further impregnated with a (NH₄)₆Mo₇O₂₄.4H₂O aqueous solution at (4.14 g/100 ml, pH=7-8), following the procedure of example 6. The amount of MoOx (a mixture of MoO₂ and MoO₃) was 0.07 mg corresponding to 11 wt % of the total mass of the activating materials (about 1 wt % of the total anode mass).

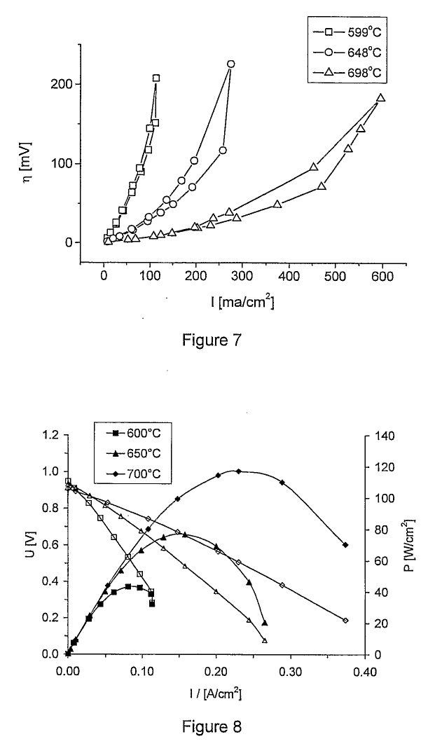

FIG. 7 shows the polarization curves of anodes based on said Cu-SDC cermet activated with MoOx+Ni+CeO₂ at three different temperatures, 599, 648 and 698° C. From this figure it is seen that the anode is active towards methane oxidation, and at 698° C. an anodic polarization of 50 mV corresponds to the current density of 0.37 A/cm².

FIG. 8 shows the characteristic performance of a fuel cell MoO+Ni+CeO₂—(Cu-SDC)/SDC/Pt+PrO₂₋ₓ, fed with CH₄ at 600, 645 and 700° C. The electrolyte was 0.0560 cm thick. The measured OCV voltages (U_{oc}) are near 0.9 V, and a maximum power density of 0.120 W/cm² was measured at 0.21/Acm² at 700° C.

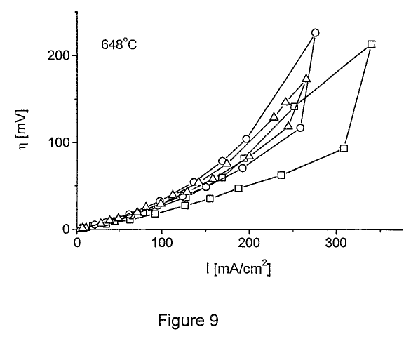

The stability of the activated anode was tested in CH₄ atmosphere. FIG. 9 illustrates anodic polarization curves recorded in CH₄/air fuel cell after 25 (□) and 46 h (∘) in CH₄+3% 1120 mixtures, and further 7 h (Δ) in CH₄+3% H₂O atmosphere. It can be seen that after an initial deactivation the anode response is stable in time.

The following Table 3 provides a comparison between the electrochemical performance of solid oxide fuel cells according to the invention, fed with CH₄, and those of the prior art fed with C₄H₁₀.

TABLE 3

| | Current density | Power density |
|---|---|---|
| SOFC | (A/cm² at 50 mV) | (W/cm²) |
| Example 7 | 0.38 at 646° C. | 0.24 at 0.45 A/cm² and 696° C. |
| Example 8 | 0.37 at 698° C. | 0.12 at 0.21 A/cm² and 700° C. |
| CeO₂—Cu-SDC* | 0.06 at 650° C. | 0.05 at 0.17 A/cm² and 650° C. |
| CeO₂—Au-SDC* | 0.10 at 650° C. | 0.05 at 0.13 A/cm² and 650° C. |

*C. Lu et al., J. Electrochem. Soc, 150(10), A1357-A1359 (2003)

In spite of the fact that the SOFC of the prior art were tested under C₄H₁₀ which, as already mentioned above, is known to be more reactive to oxidation than CH₄, their electrochemical performances is dramatically lower than those of the SOFC according to the present invention. The different temperatures in some instances applied cannot be seen as a key-factor in evaluating this disparity of performance, because the ΔT is of just 50° C. or less.

1-51. (canceled)

52. A solid oxide fuel cell comprising a cathode, an anode and at least one electrolyte membrane disposed between said anode and said cathode, wherein said anode comprises
a cermet including a metallic portion and an electrolyte ceramic material portion, said portions being substantially uniformly interdispersed, said metallic portion having a melting point equal to or lower than 1200° C. and being substantially inert as catalyst for hydrocarbon oxidation; said cermet having a porosity equal to or higher than 40%, and being activated by a catalyst for hydrocarbon oxidation in an amount equal to or lower than 20 wt %.

53. The solid oxide fuel cell according to claim 52, wherein the metallic portion is selected from a metal selected from copper, aluminum, gold, praseodymium, ytterbium, cerium, and alloys thereof.

54. The solid oxide fuel cell according to claim 53, wherein the metallic portion is copper.

55. The solid oxide fuel cell according to claim 52, wherein the metallic portion has a melting point higher than 500° C.

56. The solid oxide fuel cell according to claim 52, wherein the weight ratio metallic portion/ceramic portion in the cermet is 9:1 to 3:7.

57. The solid oxide fuel cell according to claim 52, wherein the weight ratio metallic portion/ceramic portion in the cermet is 8:2 to 5:5.

58. The solid oxide fuel cell according to claim 52, wherein the ceramic material has a specific conductivity equal to or higher than 0.01 S/cm at 650° C.

59. The solid oxide fuel cell according to claim 58, wherein the ceramic material is selected from doped ceria and La_{1-X}SrₓGa_{1-y}Mg_{y}O_{3-δ} wherein x and y are 0 to 0.7, and δ is from stoichiometry.

60. The solid oxide fuel cell according to claim 59, wherein ceria is doped with gadolinia or samaria.

61. The solid oxide fuel cell according to claim 52, wherein the ceramic material is yttria-stabilized zirconia.

62. The solid oxide fuel cell according to claim 52, wherein the cermet has a specific surface area equal to or lower than 5 m²/g.

63. The solid oxide fuel cell according to claim 62, wherein the cermet has a specific surface area equal to or lower than 2 m²/g.

64. The solid oxide fuel cell according to claim 52, wherein said catalyst is selected from nickel, iron, cobalt, molybdenum, platinum, iridium, rhutenium, rhodium, silver, palladium, cerium oxide, manganese oxide, molybdenum oxide, titania, samaria-doped ceria, gadolinia-doped ceria, niobia-doped ceria and mixtures thereof.

65. The solid oxide fuel cell according to claim 64, wherein said catalyst is selected from nickel, cerium oxide and mixtures thereof.

66. The solid oxide fuel cell according to claim 52, wherein said catalyst is present in an amount of 0.5 wt % to 15 wt %.

67. The solid oxide fuel cell according to claim 52, wherein said catalyst has a specific surface area higher than 20 m²/g.

68. The solid oxide fuel cell according to claim 67, wherein said catalyst has a specific surface area higher than 30 m²/g.

69. The solid oxide fuel cell according to claim 52, wherein the cathode comprises a metal selected from platinum, silver, gold and mixtures thereof, and an oxide of a rare earth element.

70. The solid oxide fuel according to claim 52, wherein the cathode comprises a ceramic selected from
La₁₋ₓSrₓMnO_{3-δ}, wherein x and y are independently equal to 0 to 1, and δ is from stoichiometry; and
La₁₋ₓSrₓCo_{1-y}Fe_{y}O_{3-δ}, wherein x and y are independently equal to 0 to 1, and δ is from stoichiometry.

71. The solid oxide fuel cell according to claim 69, wherein the cathode comprises doped ceria.

72. The solid oxide fuel cell according to claim 52, wherein the cathode comprises a combination of materials comprising a metal selected from platinum, silver, gold and mixtures thereof, and an oxide of a rare earth element and a ceramic selected from
La₁₋ₓSrₓMnO_{3-δ}, wherein x and y are independently equal to 0 to 1, and 6 is from stoichiometry; and
La₁₋ₓSrₓCo_{1-y}Fe_{y}O_{3-δ} wherein x and y are independently equal to 0 to 1, and 6 is from stoichiometry.

73. The solid oxide fuel cell according to claim 52, wherein the electrolyte membrane is selected from yttria-stabilized zirconia, La₁₋ₓSrₓGa_{1-y}Mg_{y}O_{3-δ} wherein x and y are 0 to 0.7, and 6 is from stoichiometry, and doped ceria.

74. The solid oxide fuel cell according to claim 52, wherein the electrolyte membrane comprises the same material of the electrolyte ceramic portion of the cermet.

75. A method for producing energy comprising the steps of:
a) feeding at least one hydrocarbon fuel into an anode side of a solid oxide fuel cell comprising:
an anode comprising a cermet comprising a metallic portion and an electrolyte ceramic material portion, said portions being substantially uniformly interdispersed, said metallic portion having a melting point equal to or lower than 1200° C. and being substantially inert as catalyst for hydrocarbon oxidation; said cermet having a porosity equal to or higher than 40%, and being activated by a catalyst for hydrocarbon oxidation in an amount equal to or lower than 20 wt %;
a cathode; and
at least one electrolyte membrane disposed between said anode and said cathode;
b) feeding an oxidant into a cathode side of said solid oxide fuel cell; and
c) oxidizing said at least one fuel in said solid oxide fuel cell, resulting in production of energy.

76. The method according to claim 75, wherein the hydrocarbon fuel is substantially dry.

77. The method according to claim 75, wherein the hydrocarbon fuel is methane.

78. The method according to claim 75, wherein the hydrocarbon fuel is directly oxidized at the anode side.

79. The method according to claim 75, wherein the hydrocarbon fuel is internally reformed at the anode side.

80. The method according to claim 75, wherein the solid oxide fuel cell operates at a temperature of 400° C. to 800° C.

81. The method according to claim 80, wherein the solid oxide fuel cell operates at a temperature of 500° C. to 700° C.

82. A process for preparing a solid oxide fuel cell comprising a cathode, an anode and at least one electrolyte membrane disposed between said anode and said cathode wherein said anode comprises a cermet including a metallic portion and an electrolyte ceramic material portion; comprising the steps of:
providing a cathode;
providing at least one electrolyte membrane; and
providing an anode
wherein the step of providing the anode comprises the steps of:
a) providing a precursor of the metallic portion, said precursor having a particle size of 0.2 μm to 5 μm;
b) providing the electrolyte ceramic material having a particle size of 1 μm to 10 μm;
c) mixing said precursor and said ceramic material to provide a starting mixture;
d) heating and grinding said starting mixture in the presence of at least one first dispersant;
e) adding at least one binder and at least one second dispersant to the starting mixture from step d) to give a slurry;
f) thermally treating the slurry to provide a pre-cermet;
g) reducing the pre-cermet to provide a cermet; and
h) distributing at least one catalyst for hydrocarbon oxidation into the cermet.

83. The process according to claim 82, wherein the slurry resulting from step e) is applied on the electrolyte membrane.

84. Process according to claim 82, wherein step h) comprises impregnating the pre-cermet with a precursor of the catalyst which is subsequently reduced during a reducing step.

85. The process according to claim 82, wherein step h) comprises impregnating the cermet with a precursor of the catalyst which is subsequently reduced during an additional reducing step i).

86. The process according to claim 82, wherein the precursor of the metallic portion is an oxide.

87. The process according to claim 86, wherein the oxide is a copper oxide.

88. The process according to claim 86, wherein the oxide is CuO.

89. The process according to claim 82, wherein the precursor has a particle size of 1 to 3 μm.

90. The process according to claim 82, wherein the ceramic material has a particle size of 2 to 5 μm.

91. The process according to claim 82, wherein step d) is carried out more than one time.

92. The process according to claim 82, wherein the at least one first and second dispersants are selected from ethanol and isopropanol.

93. The process according to claim 82, wherein the at least one first dispersant is the same as the at least a second dispersant.

94. The process according to claim 82, wherein the binder is soluble in the at least one second dispersant.

95. The process according to claim 82, wherein the binder is polyvinylbutyral.

96. The process according to claim 82, wherein step f) is carried out at a temperature of 700° C. to 1100° C.

97. The process according to claim 96, wherein step f) is carried out at a temperature of 900° C. to 1000° C.

98. The process according to claim 82, wherein step g) is carried out at a temperature of 300° C. to 800° C.

99. The process according to claim 98, wherein step g) is carried out at a temperature of 400° C. to 600° C.

100. The process according to claim 82, wherein step g) is performed with hydrogen containing from 1 vol. % to 10 vol. % of water.

101. The process according to claim 100, wherein hydrogen contains from 2 vol. % to 5 vol. % of water.

102. A cermet comprising a metallic portion and an electrolyte ceramic material portion, said portions being substantially uniformly interdispersed, said metallic portion having a melting point equal to or lower than 1200° C. and being substantially inert as catalyst for hydrocarbon oxidation; said cermet having a porosity equal to or higher than 40%, and being activated by a catalyst for hydrocarbon oxidation in an amount equal to or lower than 20 wt %.
